(19) United States
(12) Patent Application Publication
(10) Pub. No.: US 2018/0357548 A1
(43) Pub. Date: Dec. 13, 2018

(54) Recommending Media Containing Song Lyrics

(71) Applicant: Google Inc., Mountain View, CA (US)

(72) Inventors: Eric Paul Nichols, San Francisco, CA (US); Yading Song, London (GB); Justin Zhao, New York, NY (US)

(21) Appl. No.: 14/701,275

(22) Filed: Apr. 30, 2015

(51) Int. Cl. G06N 5/04; H04L 29/06

(52) U.S. Cl. CPC G06N 5/04; H04L 67/42

(57) ABSTRACT

A content server stores video and audio, and other media containing songs. One or more seed songs associated with seed lyrics and a client device are obtained. A seed feature vector characterizing the seed lyrics is obtained. A song lyric corpus including candidate feature vectors characterizing candidate song lyrics of candidate songs is accessed. Song lyric features are stored in the song lyric corpus to facilitate identification of candidate lyrics most similar to the seed lyrics. The candidate feature vectors in the song lyric corpus may be reduced-dimension versions of high-dimensional feature vectors quantifying characteristics of the song lyrics. One of the candidate songs is selected according to a measure of similarity between the seed feature vector and one of the candidate feature vectors corresponding to the selected candidate song. A song recommendation including the selected candidate song is generated and provided to the client device associated with the song.

### BACKGROUND

### 1. Field

The disclosure generally relates to the field of identifying similar media, and in particular, to identifying media having similar song lyric content.

### 2. Description of the Related Art

A content server allows users to upload media (also referred to as content) such as videos, audio, images, and/or animations. Other users may experience the media using client devices to browse media hosted on the content server. The content server may recommend content to users. Many existing content servers use collaborative filtering to generate recommendations for content. Collaborative filtering identifies users who exhibit similar behaviors (e.g., views, plays, ratings, likes, dislikes) with respect to content. Commonalities in those behaviors may then be used to indicate content to recommend to any individual user.

However, collaborative filtering may not account for the idiosyncrasies of individual users' tastes or accurately predict a listening user's reaction to content experienced by only a few users. Other types of analysis, such as content-based recommendations, can predict a user's reaction to newly uploaded content by comparing inherent characteristics of the content to previous content the user has experienced. However, analyzing content such as audio and video to identify characteristics is both computationally intensive and often inaccurate.

### SUMMARY

A content server stores video and audio, and other media containing songs. One or more seed songs associated with one or more seed lyrics and a client device are obtained. A seed feature vector characterizing the seed lyrics is obtained. A song lyric corpus including candidate feature vectors characterizing candidate song lyrics of candidate songs is accessed. Song lyric features are stored in the song lyric corpus to facilitate identification of candidate lyrics most similar to the seed lyrics. The candidate feature vectors in the song lyric corpus may be reduced-dimension versions of high-dimensional feature vectors quantifying characteristics of the song lyrics. One of the candidate songs is selected according to a measure of similarity between the seed feature vector and one of the candidate feature vectors corresponding to the selected candidate song. A song recommendation including the selected candidate song is generated and provided to the client device associated with the song.

The disclosed embodiments include a computer-implemented method, a system, and a non-transitory computer-readable medium. The features and advantages described in this summary and the following description are not all inclusive and, in particular, many additional features and advantages will be apparent in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description and the accompanying figures. A brief introduction of the figures is below.

FIG. 1 is a block diagram of a networked computing environment for experiencing media, in accordance with an embodiment.

FIGS. 2A and 2B are block diagrams of an example lyric analyzer and an example recommendation engine, respectively, in accordance with an embodiment.

FIG. 3 is a block diagram of an example feature generator, in accordance with an embodiment.

FIG. 4 is a flowchart illustrating an example process for generating a song lyric corpus, in accordance with an embodiment.

FIG. 5 is a flowchart illustrating an example process for recommending a song, in accordance with an embodiment.

FIG. 6 is a level block diagram illustrating an example computer usable to implement entities of the content sharing environment, in accordance with one embodiment.

### DETAILED DESCRIPTION

The figures and the following description relate to particular embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. Alternative embodiments of the structures and methods illustrated herein may be employed without departing from the principles described herein.

### I. System Architecture

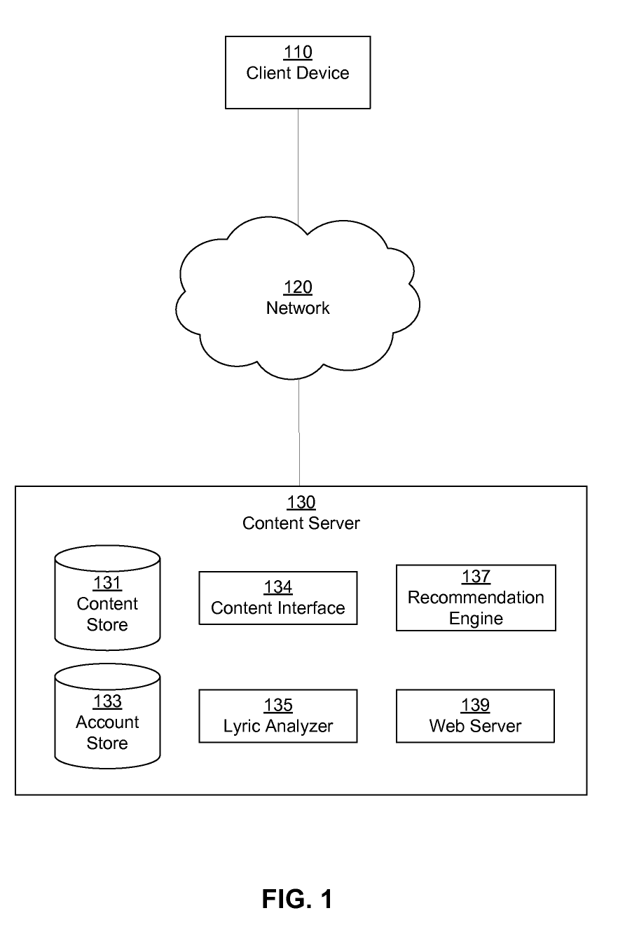

FIG. 1 illustrates a block diagram of a networked environment for sharing media, in accordance with one embodiment. The entities of the networked environment include a client device 110, a content server 130, and a network 120. Although single instances of the entities are illustrated, multiple instances may be present. For example, multiple client devices 110 associated with multiple users may request and present media to multiple content servers 130. The functionalities of the entities may be distributed among multiple instances. For example, a content distribution network of servers at geographically dispersed locations implements the content server 130 to increase server responsiveness and to reduce media loading times.

A client device 110 is a computing device that accesses the content server 130 through the network 120. By accessing the content server 130, the client device 110 may carry out user-initiated tasks that are provided by the content server 130 such as browsing media, presenting media, or uploading media. Media (or content) refers to an electronically distributed representation of information and includes videos, audio, images, animation, and/or text. To present media, the client device 110 may play a video or audio file or may display an image or animation, for example.

The client device 110 may receive from the content server 130 identifiers of media recommended for the user and present a media preview of the recommended media to the user. The media preview may be a thumbnail image, a title of the media, and a playback duration of the media, for example. The client device 110 detects an input from a user to select one of the media previews and requests the media corresponding to the selected media preview from the content server 130 for playback through an output device (e.g., display, speakers) of the client device 110.

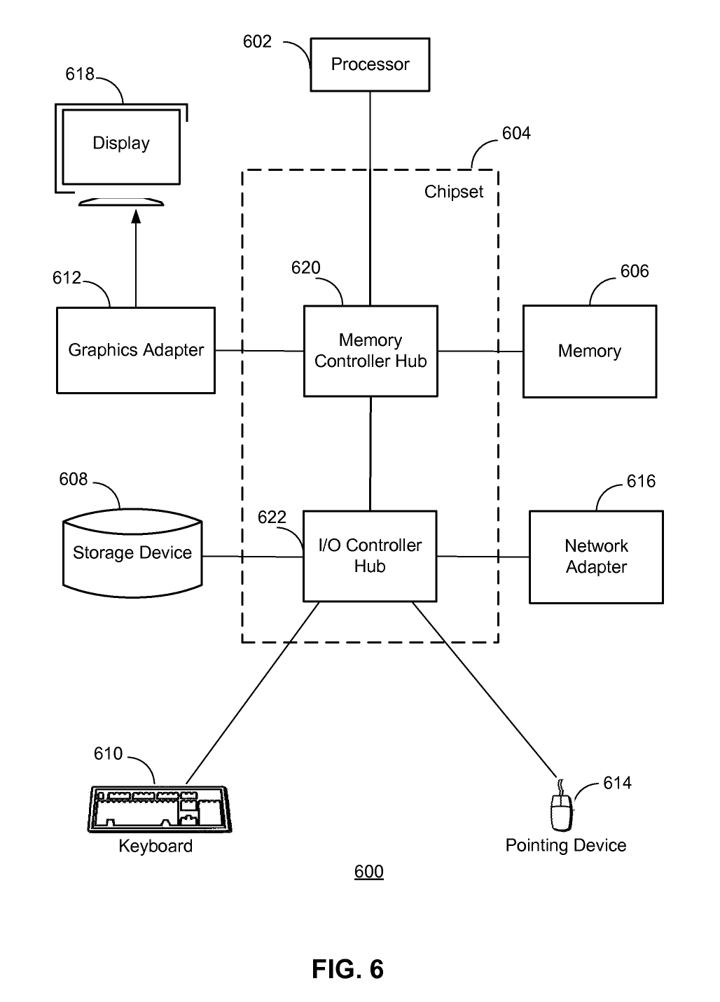

The client device 110 includes a computer, which is described further below with respect to FIG. 6. Example client devices 110 include a desktop computer, a laptop, a tablet, a mobile device, a smart television, and a wearable device. The client device 110 may contain software such as a web browser or other application for presenting media from the content server 130. The client device 110 may include software such a video player, an audio player, or an animation player to support presentation of media.

The content server 130 stores media, in some cases uploaded by a user through a client device 110, and serves uploaded media to a listening user through a client device 110. The content server 130 may also store media acquired from content owners (e.g., production companies, record labels, publishers). The content server 130 generates and provides the recommendations to client devices 110. For instance, if a client device 110 presents a music video, then the content server 130 is configured to recommend other music videos similar to the presented music video. In one embodiment, the content server 130 recommends one or more songs or media containing those songs (e.g., music videos) having song lyrics with characteristics related to characteristics of song lyrics of a seed song (e.g., from a recently presented music video).

A song refers to media (typically audio or video) representing music associated with a song lyric. A song lyric is a collection of words accompanying music. Song lyrics include both audible words (e.g., sung, rapped, chanted, or spoken words) and visible words (e.g., printed words or gestured words as in sign language). Words are meaningful elements of speech and may include both semantically meaningful words and semantically meaningless words (e.g., gibberish or representations of vocalizations).

In one embodiment, the content server 130 includes a content store 131, an account store 133, a content interface module 134, a lyric analyzer 135, a recommendation engine 137, and a web server 139. The functionality of the illustrated components may be distributed (in whole or in part) among a different configuration of modules. Some described functionality may be optional; for example, in one embodiment the content server 130 does not include an account store 133.

The content server 130 stores songs and other media in the content store 131. The content store 131 may be a database containing entries each corresponding to a song and other information related to the song. The database is an organized collection of data stored on one or more non-transitory, computer-readable media. A database includes data stored across multiple computers whether located in a single data center or multiple geographically dispersed data centers. Databases store, organize, and manipulate data according to one or more database models such as a relational model, a hierarchical model, or a network data model.

The entry for a song in the content store 131 may include the song itself (e.g., the audio or video file) or a pointer (e.g., a memory address, a uniform resource identifier (URI), an internet protocol (IP) address) to another database storing the song. A song's entry in the content store 131 may indicate associated metadata, which are properties of the media and may indicate the media's source (e.g., an uploader name, an uploader user identifier) and/or attributes (e.g., a video identifier, a title, a description, a file size, a file type, a frame rate, a resolution, an upload date, a channel including the media). Metadata associated with media may also include a pointer to song lyrics associated with media, or the song lyrics themselves. The song lyrics may be stored as text as in a song's entry in the content store 131 or in another database.

The account store 133 contains account profiles of content server users. The account store 133 may store the account profiles as entries in a database. An account profile includes information provided by a user of an account to the content server, including a user identifier, access credentials, and user preferences. The account profile may include a history of media experienced by the user, media uploaded by the user, or media included in search results from a user query to the content server 130, as well as records describing how the user engaged with experienced media. These engagement records may describe a rating provided by a user (e.g., numerical, like, dislike, or other qualitative rating), a share by the user (e.g., via a social network, email, or short message), or portions of the media presented to the user (and portions skipped by the user), for example. The recommendation engine 137 uses the media in a user's history to provide more relevant song recommendations. Insofar as the account store 133 contains personal information provided by a user, a user's account profile includes privacy settings established by a user to control use and sharing of personal information by the content server 130.

The web server 139 links the content server 130 via the network 120 to the client device 110. The web server 139 serves web pages, as well as other content, such as JAVA®, FLASH®, XML, and so forth. The web server 139 may receive uploaded content items from the one or more client devices 110. Additionally, the web server 139 communicates instructions from the content interface 125 for presenting media and for processing received input from a user of a client device 110. Additionally, the web server 139 may provide application programming interface (API) functionality to send data directly to an application native to a client device's operating system, such as IOS®, ANDROID™, or WEBOS®.

The content interface module 134 generates a graphical user interface that a user interacts with through software and input devices (e.g., a touchscreen, a mouse) on the client device 110. The user interface is provided to the client device 110 through the web server 139, which communicates with the software of the client device 110 that presents the user interface. Through the user interface, the user accesses content server functionality including browsing, experiencing, and uploading media. The content interface may include a media player (e.g., a video player, an audio player, an image viewer) that presents content. The content interface module 134 may display metadata associated with the media and retrieved from the content store 131. Example displayed metadata includes a title, upload data, an identifier of an uploading user, and content categorizations. The content interface module 134 may incorporate a search interface for browsing content or a recommendation interface presenting song recommendations generated by the recommendation engine 137.

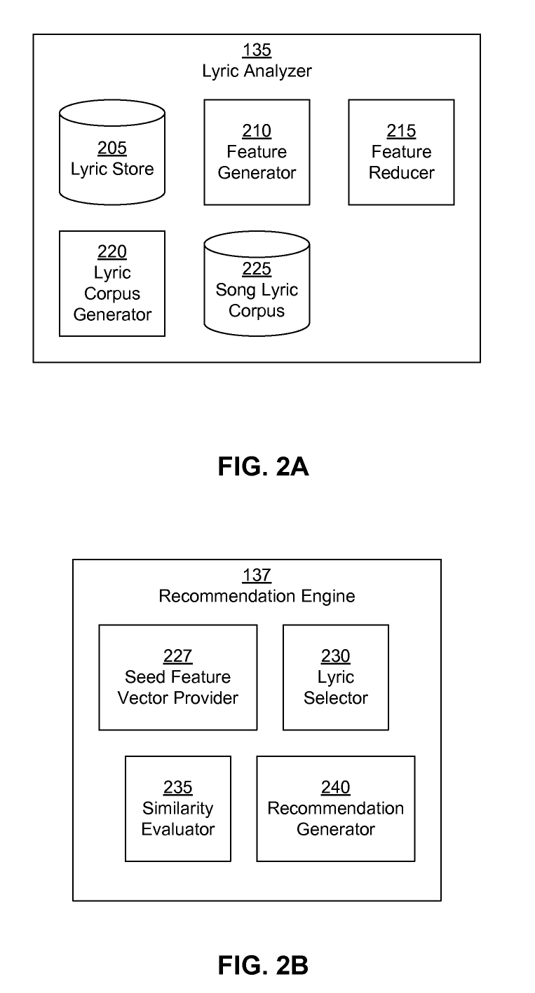

The lyric analyzer 135 obtains song lyrics associated with songs and generates feature vectors quantifying characteristics of the song lyrics. The recommendation engine 137 uses these feature vectors to generate song recommendations. A feature vector may be generated from an initial feature vector having more dimensions quantifying individual characteristics of the corresponding song lyric than the dimensions of the feature vector. Example characteristics of song lyrics include prevalence of rhymes, presence of particular words, emotional tone, rhyming structure, or musical structure. An initial feature vectors may be transformed with a dimensionality reduction to produce a corresponding feature vector. Reducing the number of dimensions beneficially increases computational efficiency of comparisons between feature vectors. Feature vectors may be stored in a song lyric corpus accessed by the recommendation engine 137. The song lyric corpus beneficially reduces processing time to generate a song recommendation by organizing song lyric data to facilitate retrieval of feature vectors corresponding to song lyrics similar to a seed lyric. The lyric analyzer 135 is described in further detail with respect to FIG. 2A.

The recommendation engine 137 obtains one or more seed songs and generates a song recommendation including other songs having similar song lyrics to seed lyrics of the one or more seed songs. The recommendation engine 137 identifies candidate songs likely to have similar lyrics to the one or more seed songs. A seed song is associated with a seed feature vector quantifying characteristics of the seed lyrics, and the candidate songs are associated with candidate feature vectors quantifying characteristics of the candidate song's song lyrics. By comparing the candidate feature vectors to the seed feature vector (or a composite seed feature vector characterizing multiple seed songs), the recommendation engine 137 selects one or more of the candidate songs. For instance, the recommendation engine 137 compares the feature vectors by determining a measure of similarity between the seed feature vector and a candidate feature vector. The one or more of the selected songs may be included in a recommendation interface generated by the recommendation interface module 134 and provided to a client device 110. The recommendation engine 137 is described in further detail with respect to FIG. 2B.

The network 120 enables communications among the entities connected thereto through one or more local-area networks and/or wide-area networks. The network 120 (e.g., the Internet) may use standard and/or custom wired and/or wireless communications technologies and/or protocols. The data exchanged over the network 120 can be encrypted or unencrypted. The network 120 may include multiple sub-networks to connect the client device 110 and the content server 130. The network 120 may include a content distribution network using geographically distributed data centers to reduce transmission times for media sent and received by the content server 130.

### II. Lyric Analyzer

FIG. 2A is a block diagram of an example lyric analyzer 135, in accordance with an embodiment. The lyric analyzer 135 includes a lyric store 205, a feature generator 210, a feature reducer 215, a lyric corpus generator 220, and a song lyric corpus 225. The functionality of the lyric analyzer 135 may be provided by additional, different, or fewer modules than those described herein.

The lyric store 205 stores song lyrics associated with songs in the content store 131. The lyrics store 205 may stores the song lyrics as text in corresponding entries of a database. The content server 130 may obtain the song lyrics by analyzing audio content, analyzing user-transcribed lyrics, receiving the song lyrics from a content owner (e.g., an artist, recording label, or media company), or a combination thereof. For instance, the content server 130 obtains and reconciles user-generated transcriptions of song lyrics to correct inconsistencies between different versions of song lyrics. Alternatively or additionally, the content server 130 transcribes lyrics from audio content by filtering frequencies outside a human vocal range from song audio, identifying non-vocalized sounds based on timbre outside the human vocal range, and applying a text-to-speech algorithm to transcribe the remaining audio. The content server 130 stores the resulting reconciled song lyrics in the lyric store 205. When song lyrics are provided by a content owner or other official source, these song lyrics may be used in place of user-transcribed or machine-transcribed song lyrics.

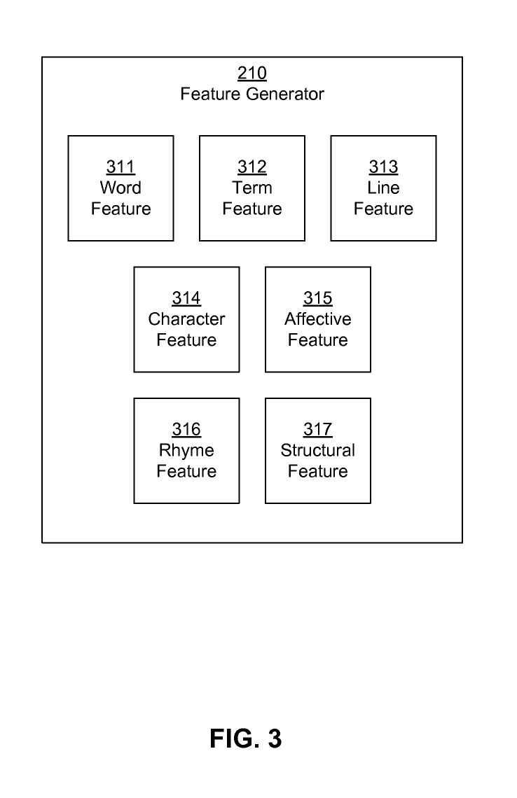

The feature generator 210 accesses song lyrics in the lyric store 205 and generates feature vectors. A feature vector quantifies characteristics of a song lyric. The quantified characteristics are generally numerical in nature, such as a count (e.g., number of rhyming word pairs) or a binary indicator (e.g., whether rhyming words are present). The feature generator 210 combines the different quantifications of different characteristics as different dimensions of the feature vector. The feature vector may be generated in a particular format specifying an order of dimensions and corresponding characteristics. Other functionally equivalent representations of a feature vector include a key/value table, an n-tuple, an array, a matrix row or column, or any other grouping of numerical values. Particular characteristics encoded in the feature vector are described in further detail with respect to FIG. 3.

The feature reducer 215 obtains a feature vector generated by the feature generator 210 and generates a dimensionally reduced feature vector from the initial feature vector. The feature vector generated by the feature generator 210 may be referred to as an “initial feature vector,” and the feature vector generated by the feature reducer 215 may be referred to as a “reduced feature vector.” The feature reducer 215 performs a dimensionality reduction algorithm to approximate the initial feature vector using fewer dimensions. In some dimensionality reduction algorithms, the feature reducer 215 determines a transform to de-correlate a set of initial feature vectors and determines a measure of information represented within each dimension of the set of transformed feature vectors. A dimension of a transformed feature vector represents a combination of characteristics of the corresponding song lyrics, and the measure of information for the dimension indicates how much a combination of characteristics differentiates the song lyrics from other song lyrics. The feature reducer 215 ranks the transformed dimensions according to the corresponding measures of information and selects a subset of the transformed dimensions according to the ranking. The selected dimensions represent those combinations of characteristics that, in the aggregate, differentiate song lyrics from each other. The feature reducer 215 may select a pre-determined number of transformed dimensions or may determine a number of transformed dimensions to select so that a total measure of information in the selected dimensions equals or exceeds a threshold.

The feature reducer 215 generates a reduced feature vector by applying the transform to an initial feature vector and by selecting the subset of transformed dimensions to form the reduced feature vector. The feature reducer 215 generates reduced feature vectors corresponding to the set of initial feature vectors used to determine the transform and stores the reduced feature vectors in the song lyric corpus 225. To add an entry to the song lyric corpus 225 corresponding to additional song lyrics not used to determine the transform, the feature reducer 215 obtains an initial feature vector corresponding to the additional song lyrics and generates a corresponding reduced feature by applying the transform determined from the set of initial feature vectors.

For instance, the feature reducer 215 may apply a dimensionality reduction algorithm such as a principal component analysis (PCA) transform to generate the reduced feature vector. The feature reducer 215 subtracts an average of the set of initial feature vectors to determine de-trended feature vectors, determines a covariance matrix of the de-trended feature vectors, and rotates the de-trended feature vectors into alignment with eigenvectors of the covariance matrix. The dimensions of the resulting rotated feature vectors no longer quantify individual characteristics of song lyrics but rather correspond to linear combinations of the quantified characteristics. The eigenvalue corresponding to a dimension of the rotated feature vectors is proportional to the variance represented in the dimension, so the feature reducer 215 uses the eigenvalue of a dimension (normalized by the total sum of the eigenvalues) as the measure of information in the dimension of the rotated feature vectors. The feature reducer 215 then selects a subset of the dimensions of the rotated feature vector to generate the reduced feature vector. As another example, the feature reducer 215 applies a different linear dimensionality reduction algorithm than PCA or applies a non-linear dimensionality reduction algorithm to project the initial feature vector onto a hyperplane or other manifold having fewer dimensions than the initial feature vector.

The lyric corpus generator 220 obtains feature vectors (e.g., reduced features vector from the feature reducer 215 or initial feature vectors from the feature generator 210) and generates the song lyric corpus 225 to store the feature vectors. The lyric corpus generator 220 may also insert, modify, or delete a feature vector from the song lyric corpus 225. For example, a newly released song is uploaded to the content server 130, the feature generator 210 generates an initial feature vector, the feature reducer 215 generates a reduced feature vector, and the lyric corpus generator 220 adds the reduced feature vector to the song lyric corpus 225. Feature vectors stored in the song lyric corpus 225 may be initial feature vectors or reduced feature vectors.

The lyric corpus generator 220 may generate the song lyric corpus 225 as a structure that facilitates identification of feature vectors similar to a seed feature vector. In one embodiment the lyric corpus generator 220 generates the song lyric corpus 225 as a k-dimensional tree (k-d tree) having nodes corresponding to feature vectors arranged in a branched tree structure. A layer of the k-d tree corresponds to a particular dimension of the feature vectors. Different branches from a node in a layer correspond to different ranges in the value of the dimension corresponding to the layer. For example, a node corresponding to a feature vector has two branches, and the node is in a layer of the k-d tree corresponding to a third dimension of the feature vectors, so the value of the third dimension of the feature vector corresponding to the node is used as a threshold value. In the example, one branch from the node includes feature vectors having a value in the third dimension exceeding the threshold value, and the other branch from the node includes feature vectors having a value in the third dimension not exceeding the threshold value. The resulting k-d tree may be accessed to find feature vectors similar to a seed vector without comparing the seed vector to every feature vector in the song lyric corpus 225.

In some embodiments, the lyric corpus generator 220 generates the song lyric corpus 225 as a structure to enable identification of similar feature vectors without guaranteeing retrieval of the feature vector most similar to the seed vector. For instance, the lyric corpus generator 220 generates the song lyric corpus 225 as one or more hashing tables indicating outputs of one or more locality-sensitive hash (LSH) functions. An LSH function deterministically maps an input to an output. In contrast to cryptographic hash functions, LSH functions have a limited number of outputs to increase the probability of hashing collisions. To take advantage of this, in one embodiment the lyric corpus generator 220 creates a hashing table including an entry for each feature vector indicating the output from an LSH function given the feature vector as input. The lyric corpus generator 220 may also generate an inverse hashing table identifying the feature vectors (and corresponding song lyrics) that correspond to a given output of the LSH function. Those feature vectors having a same output from the LSH function make up a bucket of feature vectors likely to be similar to each other. Using LSH functions reduces the dimensionality of the feature vectors, thereby obviating the feature reducer 215.

### III. Recommendation Engine

FIG. 2B is a block diagram of an example recommendation engine 137, in accordance with an embodiment. The recommendation engine 137 obtains one or more seed songs and generates a song recommendation including at least one song having song lyrics similar to seed lyrics of the one or more seed songs. The obtained seed song may be a song the user has watched as part of a video, a song identified based on a corresponding user search, or a song the user has engaged, for example. The recommendation engine 137 selects the song to recommend according to a measure of similarity between a seed feature vector quantifying characteristics of the one or more seed songs' seed lyrics and a feature vector corresponding to song lyrics to the selected song. The recommendation engine 137 includes a seed feature vector provider 227, a lyric selector 230, a similarity evaluator 235, and a recommendation generator 240. The functionality of the recommendation engine 137 may include additional, different, or fewer modules than those described herein.

The seed feature vector provider 227 accesses a user's account profile from the account store 133 and obtains a seed feature vector for recommending songs to the user. From the account store 133, the seed vector provider 227 obtains songs associated with the user, including songs experienced by the user, songs uploaded by the user, or songs included in search results from a user query to the content server 130. The songs associated with the user may include songs identified by another song recommendation algorithm (e.g., collaborative filtering). From the songs associated with the user, the seed vector provider 227 selects a seed song. For example, the seed song is a song the user is currently streaming from the content server 130. The seed feature vector provider 227 accesses the seed feature vector corresponding to the selected seed song from the song lyric corpus 225 and provides the seed feature vector to the lyric selector 230. Alternatively to accessing the seed feature vector, the seed feature vector provider 227 generates the seed feature vector according to the process described with respect to the feature generator 210 and/or the feature reducer 215.

In some embodiments, the seed feature vector provider 227 selects multiple seed songs and obtains a composite seed feature vector characterizing a composite of the seed songs. For example, the seed songs are a number of songs the user has watched most recently or has experienced most frequently within a threshold duration of a current time (i.e., time of generating the recommendation). The seed feature vector provider 227 accesses (or generates) seed feature vectors corresponding to the selected seed songs and combines the seed feature vectors to determine a composite seed feature vector. The seed feature vector provider 227 may determine the composite seed feature vector from a measure of central tendency (e.g., mean, median, mode) of the seed song vectors or a weighted combination of the seed song vectors. For example, the seed song vectors are weighted according to the songs' overall popularity, number of streams by the user, or number of engagements by the user.

In some embodiments, the seed feature vector provider 227 selects one or more seed songs from the songs associated with a user by clustering the songs associated with the user according to one or more variables describing the user's session (e.g., time, location, client device type, client device operating system, client device browser, network connection speed, network connection type) when experiencing the songs. One or more variables describing the user's current session are obtained, and the seed feature vector provider 227 selects songs in a cluster corresponding to the variables describing the user's current session. For example, the seed feature vector provider 227 identifies distinct clusters of songs associated with (1) songs provided to the user's mobile device while commuting through multiple locations in the morning, (2) songs provided to the user's desktop at a work location in the afternoon, and (3) songs provided to the user's laptop at a home location during the evening. In the example, the seed feature vector provider 227 obtains variables describing the user's current session and indicating that the user is currently experiencing songs on the user's laptop at the home location during the evening, so the seed feature vector provider 227 selects one or more seed songs from the corresponding cluster (3). The seed feature vector provider 227 accesses (or generates) one or more seed feature vectors corresponding to the selected one or more songs, combines them (if necessary) into a composite seed feature vector, and provides the composite seed feature vector to the lyric selector 230.

The lyric selector 230 obtains a seed feature vector from the seed feature vector provider 227 and selects one or more songs having song lyrics similar to those of the one or more seed songs according to a measure of similarity between the seed feature vector and a feature vector corresponding to song lyrics of the selected one or more songs. The lyric selector 230 identifies candidate feature vectors, which are a subset of feature vectors in the song lyric corpus 225 expected to have a higher measure of similarity to the seed feature vector than other feature vectors in the song lyric corpus 225. For example, the song lyric corpus 225 includes one or more LSH hash tables, and the lyric selector 230 identifies candidate feature vectors from feature vectors having an LSH hash output value matching the LSH output value of the seed vector in one or more of the LSH hash tables. Alternatively to identifying a subset of feature vectors in the song lyric corpus 225 as candidate feature vectors, the lyric selector 230 includes all the feature vectors in the song lyric corpus 225 as candidate feature vectors.

The lyric selector 230 ranks the candidate feature vectors according to measures of similarity determined between the seed feature vector and each candidate feature vector. The lyric selector 230 selects a number of songs according to the ranking of their respective candidate feature vectors. The number of songs selected may be a pre-determined number (e.g., a number of recommended songs to appear in a user interface) or may be determined from the number of candidate feature vectors having a measure of similarity equaling or exceeding a threshold measure of similarity.

In some embodiments, the lyric selector 230 may identify, rank, and select candidate feature vectors simultaneously. For example, as the song lyric selector 230 identifies the candidate feature vectors, the song lyric selector 230 compares each identified candidate feature vector to a “best match” candidate feature vector. If the measure of similarity between the identified candidate feature vector and the seed feature vector equals or exceeds the measure of similarity between the best match candidate vector and the seed feature vector, then the identified candidate feature vector replaces the current best match candidate feature vector as the best match candidate feature vector. Once the search for candidate feature vectors is complete, the lyric selector 230 selects the remaining best match candidate feature vector for use in the recommendation.

For example, the song lyric corpus 225 is a k-d tree, and the lyric selector 230 identifies the candidate feature vectors by performing a nearest neighbor search of the k-d tree. To perform the nearest neighbor search, the lyric selector 230 traverses nodes corresponding to the candidate feature vectors. The traversed nodes include the root node of the k-d tree and nodes between the root node and a node representing the seed feature vector. The lyric selector 230 traverses nodes in other branches of the k-d tree and determines whether to traverse farther down those branches according to the measure of similarity between candidate feature vectors at root nodes of the other branches and the seed feature vector. If the measure of similarity for the node of a branch equals or exceeds the measure of similarities for previously traversed nodes, the lyric selector 230 traverses additional nodes in the other branch to identify additional candidate feature vectors.

The similarity evaluator 235 accesses a seed feature vector and a candidate feature vector from the song lyric corpus 225 and determines a measure of similarity between the seed feature vector and the candidate feature vector. The measure of similarity increases as the difference decreases between corresponding dimensions of the seed feature vector and the candidate feature vector. As used herein, “similarity” between first and second song lyrics may be determined according to the measure of similarity between first and second feature vectors corresponding to the first and second song lyrics. As one example, the measure of similarity may be the cosine similarity. The measure of similarity may be determined from a measure of dissimilarity such as the L2 norm (Cartesian distance) or L1 norm (Manhattan distance). As another example, the measure of similarity may be the inverse of the Cartesian distance between the candidate feature vector and the seed feature vector. Alternatively to accessing the seed feature vector and the candidate feature vector in the song lyric corpus 225, the similarity evaluator 235 may obtain either or both feature vectors from the feature generator 210 and/or the feature reducer 215.

The recommendation generator 240 obtains one or more songs selected by the lyric selector 230 and generates a song recommendation. The generated recommendation may include a subset of the selected songs or may include all the subset of selected songs. The songs selected by the lyric selector 230 may be filtered according to preferences of the user's account profile. The recommendation generator 240 may rank the selected songs according to a user's likelihood of engagement with the song. The recommendation generator 240 may include in the ranking additional songs or other media identified according to additional recommendation techniques (e.g., collaborative filtering). The recommendation generator 240 selects songs according to the ranking and generates a song recommendation including the selected songs. The content interface module 134 incorporates the song recommendation into a user interface (e.g., as a sidebar of a video player) and provides the song recommendation to the client device 110 associated with the user.

### IV. Feature Generator

FIG. 3 is a block diagram of an example feature generator 210, in accordance with an embodiment. The feature generator 210 generates feature vectors for a song quantifying characteristics of the song. The feature generator 210 generates feature vectors including dimensions that quantify characteristics of song lyrics, but the generated feature vectors may also include dimensions quantifying other properties of a song such as musical properties (e.g., tempo, tonality, instrumentation), visual properties (e.g., brightness, number of intra-coded frames), other song metadata (e.g., song length, song data size), or characteristics of users experiencing a song (e.g., average and total number of times users have experienced a song, demographic characteristics). The feature generator 210 includes a word feature module 311, a term feature module 312, a line feature module 313, a character feature module 314, an affective feature module 315, a rhyme feature module 316, and a structural feature module 317. The feature generator 210 may include additional, different, or fewer modules than those described herein.

The word feature module 311 obtains song lyrics and determines values for a dimension of the feature vector that quantifies words in the song lyrics. A dimension of the feature vector generated by the word feature module 311 may correspond to a total number (e.g., total words, total unique words), a normalized total (e.g., total unique words per total words), or a measure of central tendency (e.g., average word length in syllables or characters, average word difficulty, average word rarity). A measure of central tendency includes an average, mean, median or mode. The rarity of a word may be determined based on a logarithm of frequency of the word among lyrics in the lyric store 205 or in an external database (e.g., the Brown University Standard Corpus of Present-Day American English). The feature vector may include a dimension corresponding to the presence of a particular word or a number of instances of a particular word (e.g., number of instances of an obscenity).

The term feature module 312 obtains song lyrics and determines values for a dimension of the feature vector that quantifies terms in the song lyrics. A term is a group of one or more words having distinct semantic meaning (i.e., a phrase). A dimension of the feature vector generated by the term feature module 312 may correspond to a total number (e.g., total terms, total unique terms), a normalized total (e.g., total unique terms per total words), or a measure of central tendency (e.g., average term length, average term rarity). The rarity of a term may be determined based on a logarithm of frequency (i.e. song lyrics containing the word per total number of song lyrics) of the term among lyrics in the lyric store 205. The feature vector may include a dimension corresponding to the presence of a particular term or a number of instances of a particular term.

The term feature module 312 may determine the term frequency-inverse document frequency (TF-IDF) of a particular term for inclusion as a dimension of the feature vector. The term feature module 312 determines the TF-IDF from the term frequency of the term in the song relative to total words (or total terms) in the song lyric. The term feature module 312 determines the inverse document frequency from the order of magnitude (e.g., logarithm) of the total number of lyrics in the lyric store 205 normalized by the number of lyrics in the lyric store 205 containing the term. In other words, the TF-IDF is normalized by the prevalence of the term.

The line feature module 313 obtains song lyrics and determines values for a dimension of the feature vector that quantifies lines in the song lyrics. A line of a song lyric indicates a rhythmic or other break and is typically indicated by a line break in song lyric text. A dimension of the feature vector generated by the line feature module 313 may correspond to a total number (e.g., total lines, total unique lines), a normalized total (e.g., total unique lines per total lines or per total words), or a measure of central tendency (e.g., average words per line, average unique words per line, average unique words per unique line).

The character feature module 314 obtains song lyrics and generates features quantifying characters in the song lyrics. Characters refer to letters, numbers, or punctuation in song lyrics. A dimension of the feature vector generated by the character feature module 314 may quantify occurrences of a particular character (e.g., a total number of exclamation points, total number of numerical digits, average number of punctuation marks per total words in lyric) or instances of consecutive characters (e.g., total number of occurrences of three consecutive question marks, average number of occurrence of consecutive characters per total words in lyric).

The affective feature module 315 obtains song lyrics and determines values for a dimension of the feature vector that indicates an affective rating of the song lyrics. An affective rating quantifies emotional content evoked by a word or set of words. Example affective ratings of a word include valence (i.e., pleasantness), arousal (i.e., intensity), and dominance (i.e., control). The affective feature module 315 obtains affective ratings corresponding to individual terms (or words) in song lyrics and determines an overall affective rating of the song lyric according to the number of occurrences of the term and the corresponding affective rating. For example, the total affective rating is an inner product of a vector indicating the affective rating of individual words and a vector indicating the number of instances (or length-normalized instances) of the word in the song lyric. The feature vector may include one or more dimensions including different total affective ratings.

The rhyme feature module 316 obtains song lyrics and determines values for a dimension of the feature vector that quantifies rhymes in the song lyrics. The rhyme feature module 316 obtains phonemes of the words in the song lyric from a pronunciation database and identifies pairs (or sets) of rhyming words. Words rhyme when the phonemes in their respective last syllables at least partially match. The rhyme feature module 316 may also identify sets of rhyming lines that end in rhyming last words. A dimension of a feature vector may quantify rhymes using total numbers (e.g., total rhyming words, total sets of rhyming words, number of rhyming lines, number of sets of rhyming lines) as well as measures of central tendency (e.g., rhyming words per word length, rhyming words per line, rhyming lines per total lines).

The structural feature module 317 obtains song lyrics and determines values for a dimension of the feature vector that quantifies structures in the song lyrics. Structures in song lyrics are multi-line patterns. The structural feature module 317 may identify rhyme-based structures following a rhyming line pattern. For example, different rhyming line patterns include AA, AABB, ABAB, and ABBA, where A refers to lines ending with words in a first set of rhyming words and B refers to lines ending with words in a second set of rhyming words. Feature vectors may have a dimension indicating a number of each type of rhyming line pattern.

The structural feature module 317 may identify parts of a song such as verses, choruses, refrains, and bridges. Parts of a song may be identified based on paragraph breaks in song lyric text, repetition of large blocks of lines, and number of lines between paragraph breaks. Feature vectors may have a dimension indicating a number of a particular type of part (e.g., number of verses, number of unique verses) or indicating the presence of a type of part (e.g., presence of a bridge).

### V. Song Lyric Corpus Generation

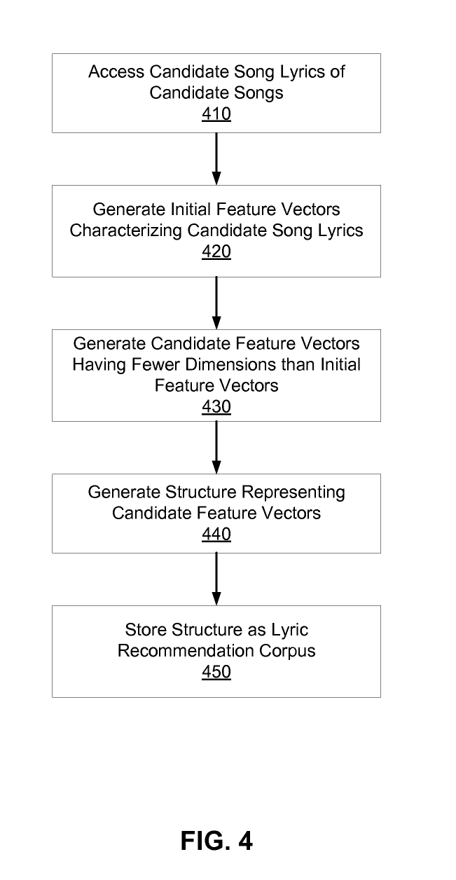

FIG. 4 is a flowchart illustrating an example process for generating a song lyric corpus 225, in accordance with an embodiment. The lyric analyzer 135 may generate the song lyric corpus 225 for later access by the recommendation engine 137. Generating the song lyric corpus 225 prior to receiving a request for a song recommendation reduces the time to provide a song recommendation by reducing computations after the time of the request. Furthermore, the structure of the song lyric corpus 225 may facilitate identifying song lyrics similar to the seed lyrics (e.g., when the structure is a k-d tree or an LSH hash table).

The lyric analyzer 135 accesses 410 candidate song lyrics of candidate songs from the lyrics store 205. The feature generator 210 generates 420 initial feature vectors having a number of dimensions, where each dimension quantifies a different characteristic of the candidate song lyrics. The feature reducer 215 generates 430 candidate feature vectors having fewer dimensions than the initial feature vector by applying a dimensionality reduction algorithm to the initial feature vectors. The lyric corpus generator 220 generates 440 a structure representing the reduced candidate feature vectors and stores 450 the structure as the song lyric corpus 225.

The process described herein may be performed in a different order or using different, fewer, or additional steps. For example, steps described as being performed sequentially may be performed in parallel. The lyric analyzer 135 is described as generating feature vectors prior to generating a song recommendation, but the lyric analyzer 135 may instead generate feature vectors in response to receiving a seed song used to generate the song recommendation. In other words, feature vectors may be generated for use by the recommendation engine 135 without being stored in the song lyric corpus 225.

### VI. Song Recommendation Generation

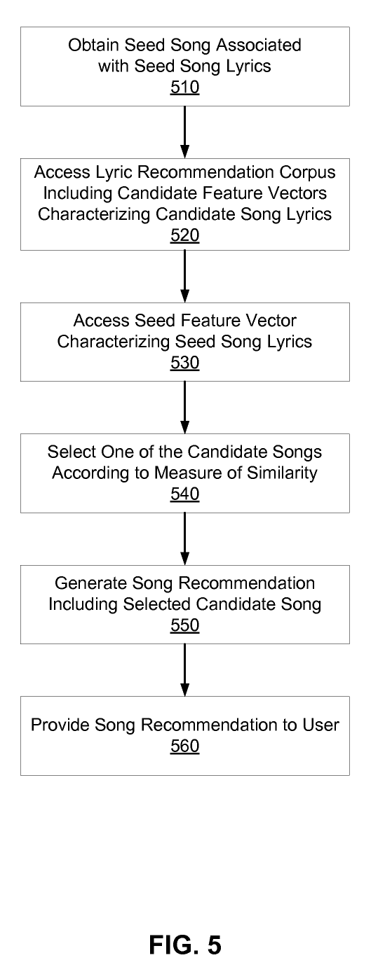

FIG. 5 is a flowchart illustrating an example process for recommending a song, in accordance with an embodiment. The recommendation engine 137 obtains 510 a seed song associated with a seed lyric. The seed song associated with a client device 110. For instance, the seed song is a video provided to the client device 110 within a threshold amount time before a current time. The lyric selector 230 accesses 520 a seed feature vector characterizing the seed lyric (e.g., from the song lyric corpus 225). The lyric selector 230 accesses 530 candidate feature vectors characterizing candidate song lyrics of candidate songs stored in the song lyric corpus 225. The candidate feature vectors accessed may be from an identified subset of feature vectors in the song lyric corpus 225 to beneficially reduce a number of comparisons between the seed feature vector and the candidate feature vectors. The lyric selector 230 selects 540 a candidate song according to a measure of similarity between the seed feature vector and a candidate feature vector determined by the similarity evaluator 235. The recommendation generator 240 generates 550 a song recommendation including the selected candidate song.

The interface module 235 provides 560 the song recommendation to the client device 110. Providing 560 the song recommendation refers to including the song recommendation in a user interface provided to the client device 110. For example, the content interface module 134 displays the song recommendation alongside a media player while a song plays or in the media player while or after the song plays, where the song is the seed song used to generate the song recommendation. As another example, the content interface module 134 presents the song recommendation as audio at the end of a seed song used to generate the song recommendation. As a third example, the content interface module 134 generates a stream or web page displaying song recommendations generated from seed songs that the user has recently experienced.

The process described herein may be performed in a different order or using different, fewer, or additional steps. For example, steps described as being performed sequentially may be performed in parallel. The recommendation engine 137 is described as accessing pre-computed feature vectors in the song lyric corpus 225, but the feature vectors may instead be computed in response to receiving a seed song used to generate a song recommendation.

### VII. Computer System

The client device 110 and the content server 130 are each implemented using computers. FIG. 6 is a level block diagram illustrating an example computer 600 usable to implement entities of the content sharing environment, in accordance with one embodiment. The example computer 600 has sufficient memory, processing capacity, network connectivity bandwidth, and other computing resources to provide song recommendations as described herein.

The computer 600 includes at least one processor 602 (e.g., a central processing unit, a graphics processing unit) coupled to a chipset 604. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

The storage device 608 is a non-transitory computer-readable storage medium such as a hard drive, compact disk read-only memory (CD-ROM), DVD, or a solid-state memory device. The memory 606 holds instructions and data used by the processor 602. The processor 602 may include one or more processors 602 having one or more cores that execute instructions. The pointing device 614 is a mouse, touch-sensitive screen, or other type of pointing device, and in some instances is used in combination with the keyboard 610 to input data into the computer 600. The graphics adapter 612 displays media and other images and information on the display 618. The network adapter 616 couples the computer 600 to one or more computer networks (e.g., network 120).

The computer 600 is adapted to execute computer program modules for providing functionality described herein including presenting media, playlist lookup, and/or metadata generation. As used herein, the term “module” refers to computer program logic used to provide the specified functionality. Thus, a module can be implemented in hardware, firmware, and/or software. In one embodiment of a computer 600 that implements the content server 130, program modules such as the lyric analyzer 135 and the recommendation engine 137 are stored on the storage device 608, loaded into the memory 606, and executed by the processor 602.

The types of computers 600 used by the entities of the content sharing environment can vary depending upon the embodiment and the processing power required by the entity. For example, the client device 110 is a smart phone, tablet, laptop, or desktop computer. As another example, the content server 130 might comprise multiple blade servers working together to provide the functionality described herein. The computers 600 may contain duplicates of some components or may lack some of the components described above (e.g., a keyboard 610, a graphics adapter 612, a pointing device 614, a display 618). For example, the content server 130 run in a single computer 600 or multiple computers 600 communicating with each other through a network such as in a server farm.

### VIII. Additional Considerations

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. To implement these operations, the content server 130 may use a non-transitory computer-readable medium that stores the operations as instructions executable by one or more processors. Any of the operations, processes, or steps described herein may be performed using one or more processors. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the embodiments. This description should be read to include one or at least one and the singular also includes the plural unless it is obvious that it is meant otherwise.

Additional alternative structural and functional designs may be implemented for a system and a process for a recommending a song. Thus, while particular embodiments and applications have been illustrated and described, it is to be understood that the disclosed embodiments are not limited to the precise construction and components disclosed herein. Various modifications, changes and variations may be made in the arrangement, operation and details of the method and apparatus disclosed herein without departing from the spirit and scope defined in the appended claims.

What is claimed is:

1. A computer-implemented method for recommending a song, the method comprising:
clustering, by a processor, a plurality of songs associated with a user of a client device based on one or more first variables describing at least one user session related to the plurality of songs;
selecting, from the clustered plurality of songs, one or more seed songs based on one or more second variables describing a current user session related to the client device;
obtaining a first feature vector comprising a first plurality of dimensions representing a plurality of characteristics of one or more seed lyrics associated with the one or more seed songs;
applying a transform to the initial feature vector to generate a transformed feature vector comprising a second plurality of dimensions, wherein each of the second plurality of dimensions represents a combination of at least two of the characteristics;
selecting a subset of the second plurality of dimensions to form a seed feature vector characterizing the one or more seed lyrics;
accessing, from a song lyric corpus, candidate feature vectors characterizing candidate song lyrics of candidate songs;
selecting, by the processor, one of the candidate songs according to a measure of similarity between the seed feature vector and one of the candidate feature vectors corresponding to the one of the candidate songs;
generating a song recommendation comprising the selected one of the candidate songs; and
providing, to the client device, the song recommendation for presentation in a user interface.

2. The method of claim 1, wherein accessing the song lyric corpus comprises accessing a candidate feature vector characterizing candidate song lyrics of a candidate song, the candidate feature vector generated by:
generating an initial feature vector comprising a first number of dimensions quantifying characteristics of the candidate song lyrics; and
generating the candidate feature vector comprising a second number of dimensions less than the first number of dimensions by applying a dimensionality reduction algorithm to the initial feature vector; and
storing the candidate feature vector in the song lyric corpus.

3. The method of claim 2, wherein generating the initial feature vector for the candidate song lyric comprises:
obtaining affective ratings corresponding to individual terms in the candidate song lyric, the affective ratings quantifying emotional content of individual terms;
determining an overall affective rating of the candidate song lyric according to numbers of occurrences of the individual terms in the candidate song lyric and the obtained affective ratings corresponding to the individual terms; and
generating the initial feature vector comprising a dimension indicating the overall affective rating of the candidate song lyric.

4. The method of claim 2, wherein generating the initial feature vector for the candidate song lyric comprises:
identifying sets of rhyming words in the candidate song lyric by matching phonemes associated with words in the candidate song lyric; and
generating the initial feature vector comprising a dimension indicating a proportion of the identified sets of rhyming words relative to total words in the candidate song lyric.

5. The method of claim 2, wherein generating the initial feature vector for the candidate song lyric comprises:
identifying rhyming lines in the candidate song lyric by matching phonemes associated with words at the end of lines in the candidate song lyric; and
generating the initial feature vector comprising a dimension indicating a number of sets of the identified rhyming lines that match a lyric rhyming pattern.

6. The method of claim 2, wherein generating the initial feature vector for the candidate song lyric comprises:
generating the initial feature vector comprising a dimension quantifying one of: a number of lines in the candidate song lyric and an average number of words per line in the candidate song lyric.

7. The method of claim 1, wherein accessing the song lyric corpus comprises accessing a candidate feature vector characterizing a candidate song lyric of a candidate song, the candidate feature generated by:
identifying a term frequency in a candidate lyric relative to a total number of words in the candidate lyric;
generating the candidate feature vector comprising a dimension indicating the term frequency in the candidate lyric normalized by a prevalence of the term among lyrics in the song lyric corpus; and
storing the candidate feature vector in the song lyric corpus.

8. The method of claim 1, wherein selecting the one of the candidate songs according to the measure of similarity between the seed feature vector and the one of the candidate feature vectors comprises:
determining a ranking of one or more of the candidate songs according to a measure of similarity between one or more corresponding candidate feature vectors and the seed feature vector; and
selecting the one of the candidate feature vectors based on the ranking.

9. The method of claim 1, wherein selecting the one of the candidate songs according to the measure of similarity between the seed feature vector and the one of the candidate feature vectors comprises:
identifying a seed node corresponding to the seed feature vector in a k-dimensional tree structure representing the song lyric corpus, nodes of the k-dimensional tree structure arranged according to candidate feature vectors corresponding to the nodes; and
determining a nearest node to the seed node by traversing the k-dimensional tree structure and comparing a measure of similarity between the seed feature vector and candidate feature vectors of traversed nodes.

10. The method of claim 1, wherein the one or more seed songs comprise a plurality of seed songs associated with a plurality of seed lyrics, and wherein obtaining the seed feature vector comprising dimensions characterizing the one or more seed lyrics comprises:
generating a plurality of seed feature vectors each comprising a first number of dimensions quantifying characteristics of one of the plurality of seed lyrics;
generating the seed feature vector comprising a second number of dimensions less than the first number of dimensions by combining the seed feature vectors and by applying a dimensionality reduction algorithm.

11. The method of claim 1, wherein the one or more songs associated with the user comprise at least one of: a song the user has watched as part of a video, a song identified based on a corresponding user search, and a song the user has engaged.

12. A non-transitory, computer-readable storage medium comprising instructions for recommending a video, the instructions executable by a processor to perform steps comprising:
clustering a plurality of songs associated with a user of a client device based on one or more first variables describing at least one user session related to the plurality of songs;
selecting, from the clustered plurality of songs, one or more seed songs based on one or more second variables describing a current user session related to the client device;
obtaining a first feature vector comprising a first plurality of dimensions representing a plurality of characteristics of one or more seed lyrics associated with the one or more seed songs;
applying a transform to the initial feature vector to generate a transformed feature vector comprising a second plurality of dimensions, wherein each of the second plurality of dimensions represents a combination of at least two of the characteristics;
selecting a subset of the second plurality of dimensions to form a seed feature vector characterizing the one or more seed lyrics;
accessing, from a song lyric corpus, candidate feature vectors characterizing candidate song lyrics of candidate songs;
selecting one of the candidate songs according to a measure of similarity between the seed feature vector and one of the candidate feature vectors corresponding to the one of the candidate songs;
generating a song recommendation comprising the selected one of the candidate songs; and
providing, to the client device, the song recommendation for presentation in a user interface.

13. The medium of claim 12, wherein accessing the song lyric corpus comprises accessing a candidate feature vector characterizing candidate song lyrics of a candidate song, the candidate feature vector generated by:
generating an initial feature vector comprising a first number of dimensions quantifying characteristics of the candidate song lyrics; and
generating the candidate feature vector comprising a second number of dimensions less than the first number of dimensions by applying a dimensionality reduction algorithm to the initial feature vector; and
storing the candidate feature vector in the song lyric corpus.

14. The medium of claim 13, wherein generating the initial feature vector for the candidate song lyric comprises:
obtaining affective ratings corresponding to individual terms in the candidate song lyric, the affective ratings quantifying emotional content of individual terms;
determining an overall affective rating of the candidate song lyric according to numbers of occurrences of the individual terms in the candidate song lyric and the obtained affective ratings corresponding to the individual terms; and
generating the initial feature vector comprising a dimension indicating the overall affective rating of the candidate song lyric.

15. The medium of claim 13, wherein generating the initial feature vector for the candidate song lyric comprises:
identifying sets of rhyming words in the candidate song lyric by matching phonemes associated with words in the candidate song lyric; and
generating the initial feature vector comprising a dimension indicating a proportion of the identified sets of rhyming words relative to total words in the candidate song lyric.

16. The medium of claim 13, wherein generating the initial feature vector for the candidate song lyric comprises:
identifying rhyming lines in the candidate song lyric by matching phonemes associated with words at the end of lines in the candidate song lyric; and
generating the initial feature vector comprising a dimension indicating a number of sets of the identified rhyming lines that match a lyric rhyming pattern.

17. The medium of claim 13, wherein generating the initial feature vector for the candidate song lyric comprises:
generating the initial feature vector comprising a dimension quantifying one of: a number of lines in the candidate song lyric and an average number of words per line in the candidate song lyric.

18. The medium of claim 12, wherein selecting the one of the candidate songs according to the measure of similarity between the seed feature vector and the one of the candidate feature vectors comprises:
determining a ranking of one or more of the candidate songs according to a measure of similarity between one or more corresponding candidate feature vectors and the seed feature vector; and
selecting the one of the candidate feature vectors based on the ranking.

19. The medium of claim 12, wherein selecting the one of the candidate songs according to the measure of similarity between the seed feature vector and the one of the candidate feature vectors comprises:
identifying a seed node corresponding to the seed feature vector in a k-dimensional tree structure representing the song lyric corpus, nodes of the k-dimensional tree structure arranged according to candidate feature vectors corresponding to the nodes; and
determining a nearest node to the seed node by traversing the k-dimensional tree structure and comparing a measure of similarity between the seed feature vector and candidate feature vectors of traversed nodes.

20. A system for recommending a video, the system comprising:
a processor;
a non-transitory, computer-readable storage medium comprising instructions executable by the processor to perform steps comprising:
clustering a plurality of songs associated with a user of a client device based on one or more first variables describing at least one user session related to the plurality of songs;
selecting, from the clustered plurality of songs, one or more seed songs based on one or more second variables describing a current user session related to the client device;
obtaining a first feature vector comprising dimensions representing a plurality of characteristics of one or more seed lyrics associated with the one or more seed songs;
applying a transform to the initial feature vector to generate a transformed feature vector comprising a second plurality of dimensions, wherein each of the second plurality of dimensions represents a combination of at least two of the characteristics;
selecting a subset of the second plurality of dimensions to form a seed feature vector characterizing the one or more seed lyrics;
accessing, from a song lyric corpus, candidate feature vectors characterizing candidate song lyrics of candidate songs;
selecting one of the candidate songs according to a measure of similarity between the seed feature vector and one of the candidate feature vectors corresponding to the one of the candidate songs; and
generating a song recommendation comprising the selected one of the candidate songs; and
providing, to the client device, the song recommendation for presentation in a user interface.
